(19) United States
(12) Patent Application Publication
(10) Pub. No.: US 2016/0127809 A1
(43) Pub. Date: May 5, 2016

(54) INTEGRATED WORK DESK SYSTEM AND METHOD FOR ENCOURAGING AND TRACKING STANDING

(71) Applicant: TOME, INC., Ferndale, MI (US)

(72) Inventors: Jacob R. SIGAL, Ferndale, MI (US); Massimo BALDINI, Beverly Hills, MI (US); Philip J. DANNE, Royal Oak, MI (US); Eric C. BARCH, Oxford, MI (US); Anthony LAWRENCE, Royal Oak, MI (US)

(21) Appl. No.: 14/929,642

(22) Filed: Nov. 2, 2015

Related U.S. Application Data
(60) Provisional application No. 62/074,120, filed on Nov. 3, 2014.

(51) Int. Cl. H04Q 9/00; G06Q 10/10; G05B 15/02; G06Q 10/06

(52) U.S. Cl. CPC H04Q 9/00; G06Q 10/063114; G06Q 10/1095; G05B 15/02; H04Q 2209/40

(57) ABSTRACT

A work desk system is disclosed which is integrated into a corporate work environment. The work desk system includes a work desk which can be raised and lowered to promote performing various activities such managing email, carrying out a telecon, participating in a webinar, while standing rather than seated. The system is able to determine from the user's calendar when certain events are upcoming that could be performed while standing, and is able to notify the user with a message on the user's computing device of the opportunity to perform the event while standing. The system is able to monitor whether the user is seated or standing, in one implementation using an intelligent caster associated with a chair present at the work desk. The system also logs the accumulated time that the worker spends standing, and shares the information with other subsystems (health applications, health care provider, corporate entity that employs the user, etc.).

### CROSS-REFERENCE TO RELATED APPLICATIONS

This application claims the benefit of U.S. Provisional Application No. 62/074,120, filed on Nov. 3, 2014, the entire disclosure of the above application is incorporated herein by reference.

### FIELD

The present disclosure relates to work desks often used in business, corporate and even home environments, and more particularly to an integrated work desk that can be raised and lowered to accommodate both seated and standing working positions, and which is able to sense when the user is seated in a chair used at the work desk, and is also integrated into a communications system to enable a computer at the work desk to communicate with a corporate email/calendar server, with a user's smartphone, and with cloud-based servers, for the purpose of tracking use of the work desk while the user is standing, as well as notifying the user via pushed notifications and analysis of the user's calendar when standing is recommended for a specific upcoming task such as a telecon or meeting.

### BACKGROUND

The statements in this section merely provide background information related to the present disclosure and may not constitute prior art.

Interest in health and fitness has increased significantly in the past few years. People are generally more conscious and interested in finding ways to exercise, and especially in activities that are easy to integrate into everyday schedules and routines. Improved cardiovascular health and weight reduction for some individuals can mean more energy available throughout the day, improved attentiveness at work and at home, as well as improved mood and improved general well-being.

While visits to health clubs before or after work are possible by some individuals, with many other individuals, family commitments, or even work or travel commitments, make it difficult to follow a routine at a health club. Spending time at a health club also takes away from the limited family or free time that individuals have outside of work. An inability to maintain a commitment to a health club often leads to complete abandonment of health objectives.

Many individuals are now involved with desk or office type jobs and occupations where it is common to spend long periods of time seated at a computer terminal or making or fielding number phone calls. Many individuals working in an office environment spend a good part of every work day sitting for long stretches of time in front of a computer or talking on the phone. Even in a home environment, it is now common to have a home office set up where one can work at home part time, or even full time, performing computer related work such as checking and sending emails, managing calendar appointments, creating reports or spreadsheets, etc., all usually performed while the user is seated at a conventional desk.

It is now becoming more understood that sitting for long periods of time every day can have adverse effects on one's cardiovascular health. It is also becoming increasingly understood and accepted that standing for a few hours a day while working on typical tasks such as writing, reading, working at a computer, etc., can have significant health benefits. Some studies have concluded that simply standing while performing tasks that would otherwise usually be performed while seated (e.g., reading, writing, computer work) will cause the body to burn up to 0.7 calories per minute more than would otherwise be burned if the individual had been seated (e.g., see http://www.bbc.com/news/magazine-24532996, “Calorie Burner: How much better is standing up than sitting?”). Of course, over an entire year, standing for several hours a day can result in a very significant quantity of extra calories being burned by an individual. In one estimate, standing for several hours a day can burn about an extra 30,000 calories per year, or the equivalent of running 10 marathons (see BBC.com article quoted above). Other findings as to the benefits of standing for prolonged periods of time while working have shown that glucose blood levels fell back to normal after a meal far more quickly when an individual stands for prolonged periods during the day after a meal, and further that standing for prolonged periods of time throughout the day can even help to reduce levels of triglycerides and fats in the flood, thus possibly decreasing the risk of heart disease (see BBC.com article quoted above). As a result, there is a strong interest in having individuals stand for lengths of time during a normal work day rather than sit. Simply encouraging workers to stand for a few hours per day while working at tasks such as writing, reading, emailing, managing calendar appointments, working on spreadsheets, conducting teleconferences, participating in video conferences or webinars, etc., can be expected over time to help increase the health and wellbeing of workers. In turn, these health benefits can be expected to help reduce an employer's health care costs for its employees.

Encouraging workers to stand while working at their work desks would be more easily achieved if the user's work desk could be integrated to other external or cloud-based subsystems, such as a user's calendar, that could monitor the user's orientation (i.e., seated or standing), along with her/his occupancy at their work desk, and recommend or remind, the user when a specific calendar event (e.g., video conference or webinar) is about to begin that may easily be carried out while standing rather than seated.

If would further be helpful if the periods of time that users perform their work while standing is logged or tracked by some external system, and then used with a “gamification” subsystem to foster competition between workers to see which worker(s) can optimize their standing times during a given period. An employee that has the highest performance score at the end of “a predetermined time period (e.g., a calendar month) may then be awarded win a prize. Such a system could help to encourage workers to stand for reasonable periods throughout the day and while performing those work related activities that can easily be performed while standing. Such periodic standing activity spaced apart throughout a work day would encourage each individual to be more active while at their work desks performing work related tasks, would provide low level aerobic activity throughout the work day, and would likely over time improve the worker's health and well being.

It would also be desirable if accurate measurements could be optically taken of the user to gain a picture of the user's overall height, height from the elbow to the eyes and other biometric criteria associated with the user, and actual measurements made relative to the floor surface on which the user's chair is present, to automatically control the height of a work desk so that the work desk is automatically positioned at an optimum height for the user, considering the user's biometric features. It would also be desirable if the user was provided with a means to “fine tune” the recommended height adjustment and to save the fine tuned, adjusted desk height for future use.

### SUMMARY

In one aspect the present disclosure relates to a furniture component system operable to monitor use of a furniture component of the furniture component system by a user. The system may comprise an electronic caster system coupled to the furniture component for helping to provide rolling movement of the furniture component along a floor surface, and for sensing when an individual is present on the furniture component, and for communicating information relating to the presence of the individual on the furniture component. The system may also comprise a remotely located management system configured to wirelessly communicate with the electronic caster, and to receive information relating to when the user is present on the furniture component.

In another aspect the present disclosure relates to a method for monitoring use of a furniture component by a user. The method comprises using an electronic caster system coupled to the furniture component to help provide rolling movement of the furniture component along a floor surface. The method also involves using the electronic caster system to sense when an individual is present on the furniture component. A wireless communications system is also used which is associated with the electronic caster system to relate a presence of the individual on the furniture component. A remotely located management system, configured to wirelessly communicate with the electronic caster, is used to receive information relating to when the user is present on the furniture component.

In still another aspect the present disclosure involves a system for controlling a height position of a monitor positioned adjacent a desk surface of a work desk, wherein the monitor includes a camera. The system comprises a height adjustment control system including a support member for supporting the monitor and positioning the monitor at a selected elevation. A motor control system is included for adjusting a height of the desk surface of the work desk. The height adjustment system and the motor control system are used to adjust at least one of an elevational position of the support member or the desk surface height to place the monitor at a comfortable viewing elevation for the user.

### BRIEF DESCRIPTION OF THE DRAWINGS

The drawings described herein are for illustration purposes only and are not intended to limit the scope of the present disclosure in any way.

FIG. 1 is a high level block diagram of a system in accordance with one embodiment of the present disclosure for implementing a treadmill desk in communication with a cloud-based management system for monitoring activity on the work desk and supplying information to an enterprise associated with the treadmill desk, as well as implementing gamification activities to help promote use and enjoyment of the treadmill desk by workers of the enterprise;

FIG. 2 is a high level block diagram of one embodiment of an integrated work desk in accordance with the present disclosure; and

FIG. 3 is a high level block diagram of an alternative implementation of the system of the present disclosure which provides for automatic height adjustments of a work desk and a separate automatic height adjustment of a monitor screen, based on user inputs and/or optically sensed physical features (e.g., eyes, elbows, etc.) of the user and physical measurements made with reference to a floor surface that the user is standing on or seated over in a chair.

### DETAILED DESCRIPTION

The following description is merely exemplary in nature and is not intended to limit the present disclosure, application, or uses. It should be understood that throughout the drawings, corresponding reference numerals indicate like or corresponding parts and features.

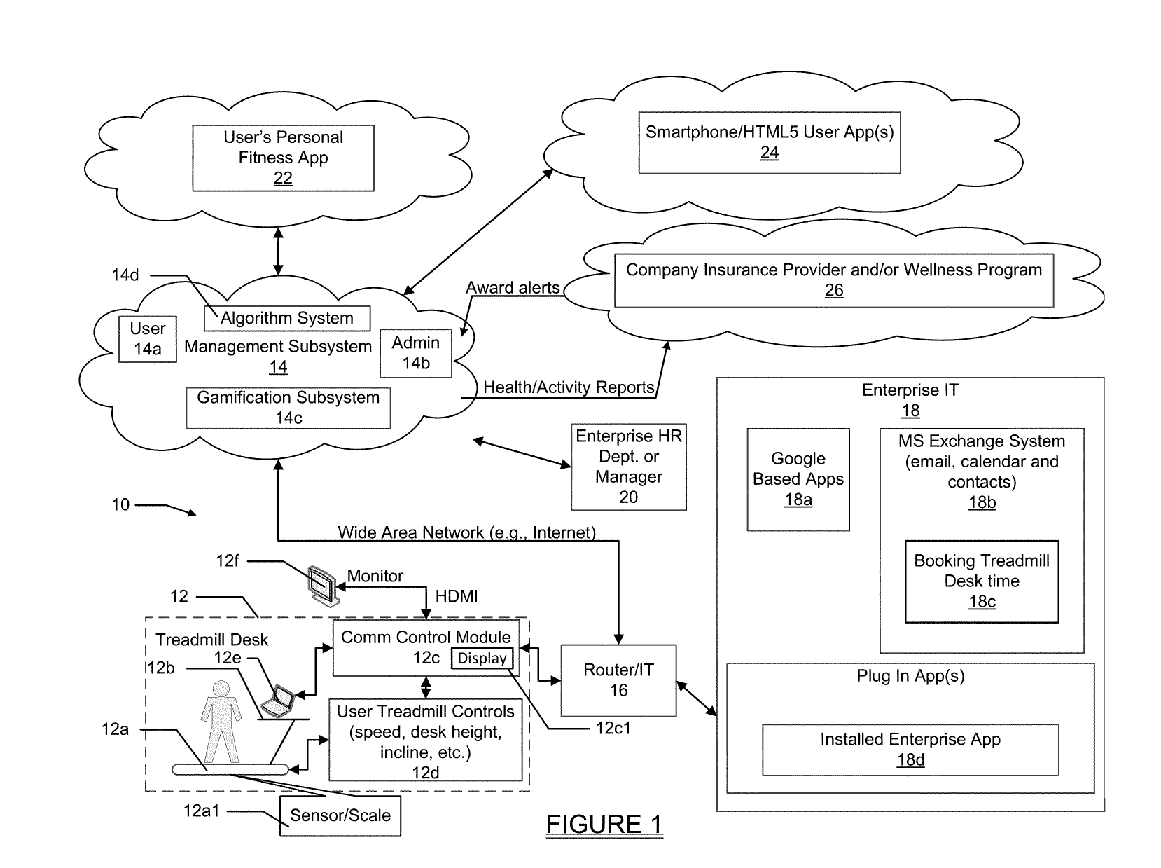

Referring to FIG. 1 there is shown a system 10 including a gamified exercise apparatus in accordance with one embodiment of the present disclosure. The system in this example may employ a combination exercise apparatus, in this example a treadmill 12a, and desk 12b, which collectively will be referred to throughout as a “treadmill desk” 12. The treadmill desk 12 in this example is in communication with a cloud-based management subsystem 14. While the term “treadmill desk” has been used to illustrate the use of a treadmill 12a in connection with a desk 12b, it will be appreciated that other exercise implements could potentially be used. For example a recumbent bicycle or potentially even a stair stepper mechanism could be used in place of a treadmill, and therefore the present disclosure is not limited to only one specific form of exercise implement. It is anticipated that a treadmill will be especially desirable as the exercise implement simply because it places the user in an upright position that makes it easy and convenient to work on a keyboard, view a monitor, hand write notes on a note pad if needed, and/or talk on a cell phone or land line telephone while walking. As such, merely for convenience, reference will be made throughout the following discussion to the exercise implement as being a treadmill.

The treadmill 12a may include a weight sensor or scale 12a1 to determine when the user is standing on the treadmill, as well as possibly the user's weight. This information may be fed to a communications control module 12c and/or displayed on a display 12c1.

The communications control module 12c may be associated with user controls 12d. A computing device, for example a laptop 12e, may be connected to the communications control module 12c. Alternatively, the user's smartphone may be connected to the communications control module 12c or a desk top computer could be installed at the work desk 12b. In either event, the user's smartphone 13, the user's tablet or other personal electronic device may communicate with the communication control module through a short range, wireless communications link, for example a Bluetooth® protocol wireless communications link, a ZigBee protocol wireless link, or any other suitable form of wireless near field communications link. In this manner the user who is using the treadmill 12a can be identified to the system 10.

The user controls 12d may provide controls for allowing the user to adjust the speed of the treadmill 12a, the incline, an interval program stored on the treadmill 12a, a height of the work desk 12b, or any other feature to enhance user comfort and/or convenience when using the treadmill 12a. The communications control module 12c may be coupled via a suitable cable, for example an HDMI cable, to a larger remote monitor 12f positioned for convenient viewing by the user while walking on the treadmill. Viewing the remote monitor 12f may be preferable to the user when watching webinars, presentations or other events. The communications control module 12c may include a display 12c1 which shows a calendar displaying availability of time slots which are open for reservation by users. The display 12c1 may also be used to display time slots for the day, week or longer which are already booked by users. The display 12c1 may be a touchscreen display which allows users to book a time slot for using the treadmill desk 12.

A smartphone 13 may include a suitable smartphone application to enable communication with the management subsystem 14. This enables the user to reserve use of one or more treadmill desks 12 from the user's smartphone. Of course, the smartphone 13 could be substituted for a tablet or even a PC.

The communication control module 12c may be coupled to a router 16 which connects the treadmill desk 12 to an enterprise IT system 18. The router 16 may also be tied in to a wide area network, for example the Internet, to enable the treadmill desk 12 to communicate with the management subsystem 14. An enterprise HR department 20 or HR manager may also be in communication with the enterprise IT system 18. The enterprise IT system 18 may communicate with the management subsystem 14 as well as the communications control module 12c through the router. Essentially, the communications control module 12c, enterprise IT system 18 and management subsystem 14 may share any information pertaining to operation of the treadmill desk 12 that may be useful and/or important for the management subsystem 14 or the enterprise IT system 18 to have. The management subsystem 14 may be a third party, cloud-based subsystem operated independently of the enterprise, but under an agreement with the enterprise. The management subsystem 14 controls access to data and resources housed and managed by the subsystem 14.

The management subsystem 14 may include a user portal 14a that users of the treadmill desk 12 may access for various purposes Examples of user portal functionality may include providing user access to the past usage history of users (e.g., dates of use, calories burned, miles walked, time spent, points earned, etc.), set preferences (desk height, belt speed, incline, etc.), and to facilitate scheduling future treadmill desk 12 appointments. An “Admin” portal 14b allows access to the management subsystem 14 by administrators of the subsystem. A gamification subsystem 14c allows gamification to programs to be implemented and managed by the management subsystem 14. The gamification subsystem 14c will be described in greater detail in the following paragraphs, but essentially it may contain and/or manage any programs or competitions for encouraging use of the treadmill desk 12 by users in ways that enhance enjoyment and participation among users. Such programs may involve sending out email notices, typically by the management subsystem 14 (but potentially via the enterprise IT system 18) to users informing/reminding them when an activity on the user's calendar (e.g., viewing a webinar, corporate training video, etc.) would lend itself well to performing while using the treadmill desk 12.

Another example of tracking usage of the treadmill desk 12, which encourages participation by users, could be creating a “points” (gamification) system whereby users are awarded points based not only on the minutes logged on the treadmill desk, but also possibly on a plurality of other metrics such as miles logged, calories burned, visits, sessions, etc. All of these factors could be used with a suitable algorithm to award users points for using the treadmill desk 12. The management system 14, which is in communication with the system 10, may keep track of the points accumulated by different users of the treadmill desk 12 and maintain scorecards for individuals with the most points on the treadmill desk 12. Still another example could be helping to promote favorite charities of employees by managing competitions among users to see who can accumulate the most points on the treadmill desk 12 in a given week, month or year, and then allowing the winner to name his/her charity of choice that the enterprise could make a donation to. Still another example of gamification could be having contests among employees of the enterprise for the most minutes (or possibly miles) logged on the treadmill desk in a given month or year, and providing additional vacation time to the winner. Other possible competitions could involve tracking the number of calories burned by employees, or possibly the number of points accumulated by teams of employees, or possibly employees from various departments of the enterprise, and awarding the winner (or team or department) a prize at the end of the competition. In one embodiment the administrative personnel at the management subsystem 14 may be responsible for managing the gamification of the treadmill desk 12. In other embodiments the administrative personnel may use input from the enterprise it is supporting to set up and implement different gamification-type contests or programs to increase and monitor user participation of the treadmill desk 12. Input may come specifically from the enterprise HR (human resources) department 20 or from other groups/levels/individuals within the enterprise. It will be appreciated that the above examples are but a small number of possible contests/programs that could be implemented via the gamification subsystem 14c to promote/track/enhance use and enjoyment of the treadmill desk 12 among users.

In other embodiments the management subsystem 14 may be able to communicate with a specific user's cloud-based personal fitness application 22. This enables the system 10 to report the minutes logged by a specific user to her/his personal fitness program. The management subsystem 14 may also be in communication with other cloud-based smartphone user applications 24 that the user may wish to employ in connection with her/his operation of the treadmill desk 12.

Still further, the management subsystem 14 may be in communication with a health insurance provider or wellness program 26 associated with the enterprise where the treadmill desk 12 is located. The management subsystem 14 could be used to generate and provide health or activity reports for those individuals who log minutes on the treadmill desk 12. The activities of users could be used by the enterprise insurance provider and/or a wellness program being used by the enterprise to provide premium discounts to those individuals who meet certain use goals on the treadmill desk 12, for example meeting a goal of a certain number of hours logged over the course of a calendar year. If an individual is within a reasonable reach of a participation goal set by the insurance provider, the insurance provider could potentially provide messages to the enterprise IT system 18 through the management subsystem 14, which could be provided to the individual via email notices sent on the enterprise's email system. The email messages may alert the individual on how many additional minutes or hours of activity on the treadmill desk 12 would provide the individual with an award or prize. This may further be used to enhance and encourage participation of the treadmill desk 12.

The enterprise IT system 18 may be based on one or more applications 18a from Google, Inc. of Mountain View, Calif., or on the Microsoft Exchange® server management system 18b (emails, calendar and contacts management) available from Microsoft Corp. of Redmond, Wash., or any other applications or platforms, and is therefore not constrained to any one type of application or platform. Plug-in applications 18c may involve specific applications for enabling users to book or reserve time slots on the treadmill desk 12 or any other applications that enhance the convenience of reserving or using the treadmill desk 12.

The user can schedule the treadmill desk 12 in several different ways. For one, the treadmill desk 12 may be scheduled as a meeting resource similar to the way that a conference room or projector can be added to a meeting appointment. This may be done using the normal mechanism in the Microsoft Outlook® email application. (This runs in 18a/18b). Another way to schedule is by including treadmill@workdesk.com (example email address) in the meeting invitation created in the Microsoft Outlook® email application or using Google applications. Still another option is using an API (Application Programming Interface) for custom third party asset/resource scheduling and/or measurements systems.

When using an email-based system for scheduling, the management subsystem 14 receives the email and based on the user that sent the email, the management subsystem 14 matches her preferred (and available) treadmill desks to the meeting time. The management subsystem 14 may then respond that the treadmill desk 12 will attend the meeting along with the specific treadmill desk 12 (assuming a plurality of treadmill desks are available for use at the enterprise) that the user should use. If there is no treadmill desk 12 available at the meeting time, an email is sent to the user indicating so and offering other available times and/or treadmill desks that are available but not on her/his preferred list. This scenario may be executed in the management subsystem 14.

Still another way to schedule the treadmill desk 12 will be by using the management subsystem 14, having been previously granted access to a user's calendar (18a/18b), to periodically scan the user's calendar. Scanning the user's calendar may be for keywords that indicate that an appointment may be conducive to working at a treadmill. If a match is found an email is then sent to the user offering to add the treadmill desk 12 to the appointments. Still another option would be using the management system 14 (or a third party custom API asset/resource scheduling system) to automatically highlight on the user's calendar, such as with a green color, those time slots where one or more time treadmill desks 12a are available (i.e., unbooked) for use. In this manner, when a user is scheduling a telecon or videoconference, the user can take into consideration those time slots where she/he knows a treadmill desk 12a will be available for use, before suggesting a time to the other party to the meeting event. This may help to maximize use of all of the available treadmill desks 12a.

Still another scheduling method may involve having the management subsystem 14 periodically review a user's usage history. When the management subsystem 14 finds that the user hasn't been on the treadmill desk 12 recently, the management subsystem 14 may send a reminder email to get up and get moving with upcoming treadmill desk availability.

Still another scheduling method may be by adding custom code that can be installed on the corporate calendar servers (18a/18b). In this manner the user interface for the appointment creation function is modified to include a checkbox for scheduling a treadmill desk 12 into the appointment. This can potentially work in several different ways: 1) ticking the checkbox has the same effect as including treadmill@workdesk.com in the appointment invitation as described above; and 2) the checkbox only appears if one or more of the users preferred treadmill desks are available. The second option immediately above would require communication between the enterprise IT system 18 and the management subsystem 14.

A number of options and/or enhancements may also be included with the system 10. For example, a scale may be installed under the treadmill belt of the treadmill desk 12, such as scale/sensor 12a1, to measure the weight of the user on the treadmill desk. The system 10 could be modified to show utilization time of the treadmill. Specifically, showing the amount of time reaming for a scheduled user, and if there is open time, using the management subsystem 14 to proactively find new users to automatically fill all or part of a given time slot where the treadmill desk 12 is free for use. The management subsystem 14 could be used to notify users (e.g., by email messages) that an increased number of points or other reward incentives is currently available to help incentivize users to fill unused treadmill desk 12 time slots. The management subsystem 14 could also incorporate push notifications on the smartphone 13 from a given treadmill desk 12, so the treadmill desk 12 notifies one or more individuals (potentially a group of individuals) that a given treadmill desk 12 is free to use at one or more specific time slots. The management subsystem 14 could also incorporate an algorithm system 14d (shown in FIG. 1) which may be used to help facilitate user calendar automation and suggesting booking times for using the treadmill desk 12a. For example, the algorithm system 14d may include one or more algorithms for detecting specific words (e.g., “teleconference”, “meeting”, “webinar”, “videoconference”, “GotoMeeting”, “Webex”, etc.) and enable booking a treadmill desk 12, or making suggestions to the user about using the treadmill desk 12, based on the detected words. Thus, whenever the algorithm system 14d detects a certain keyword on the user's calendar, the management system 14 can proactively take action in an effort to fill up available use slots for one or more of the treadmill desks 12.

If the user's email/calendar system enables selecting the treadmill desk 12, then the user could add it to the meeting invitee list. An additional point regarding emails is that the email that is added for the treadmill desk 12 is not unique. Any user may just add a generic email (e.g. desk@workdesk.com) and the system 10 may automatically book a treadmill desk 12 based on the user's email (i.e., location where the email is coming from) and a database lookup of treadmill desks 12 that are available and in an appropriate location. This is expected to it especially easy for users to reserve time slots on one or more of the treadmill desks 12.

Still further, the system 10 may use the user's cellular phone number to notify the user with a text message that a certain activity on the user's calendar would lend itself well to performing while using the treadmill desk 12. The system 10 could just as easily alert a user that a different user has cancelled an appointment slot on the treadmill desk 12 and the treadmill desk is now available for immediate use. Accordingly, email, SMS and push notification are all technologies that may be implemented with the system 10 to maximize the opportunity for individuals to make use of the treadmill desk 12.

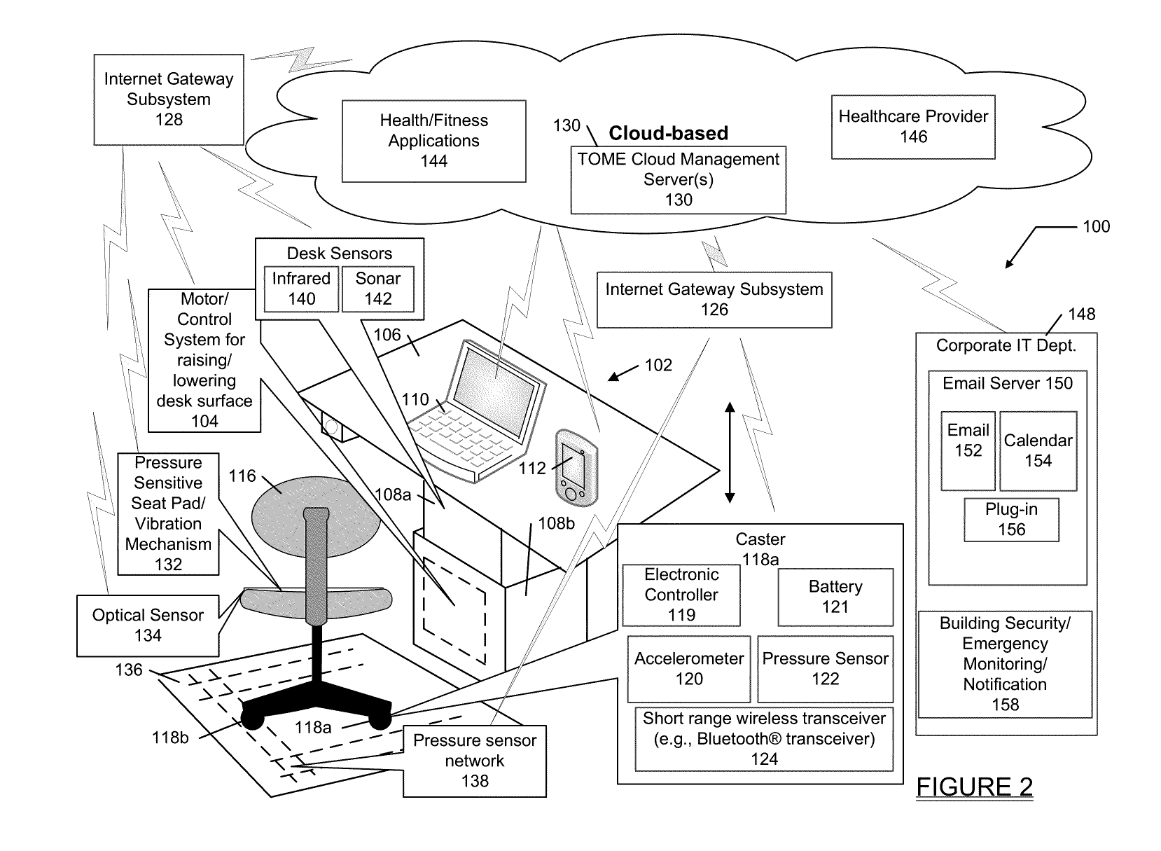

Referring to FIG. 2, there is shown one embodiment of an integrated work desk system 100 in accordance with the present disclosure. The system 100 may include a desk system 102 having a motor control system 104 for raising and lowering a desk surface 106. The motor control system 104 accomplishes this by raising and lowering a telescoping section 108a relative to a base portion 108b of the system 100. The desk surface 106 may be used to support a user's personal electronic device 110 and/or the user's smartphone 112. In this example the personal electronic device 110 is shown as a laptop computer, but any other computing device such as a desktop computer, a computing tablet, etc. may be positioned on the desk surface 106 and used with the system 100. The motor control system 104 also preferably includes a near field communications subsystem, for example a short range wireless communication subsystem 114, that operates in accordance with the BLUETOOTH® wireless communications protocol. However, any form of short range wireless communications subsystem, for example a ZIGBEE® protocol wireless short range subsystem, may potentially be used, and the system is not limited to use with any one such wireless subsystem.

A chair 116 may be used with the desk system 102. The chair 116 may incorporate one caster 118a and a plurality of casters 118b. Typically 3 or 4 casters 118 will be used with the chair 112, but caster 118a is preferably constructed as a retrofittable component that is different from the other casters 118b. Caster 118a forms a multi-capability sensing subsystem having at least one of an optional accelerometer 120 and a pressure sensor 122, as well as an electronic controller 119 and its own short range wireless transceiver 124 (e.g., a BLUETOOTH® wireless communications protocol transceiver). A battery 121 may be included for powering the electrical components housed in the caster 118a. Caster 118a is capable of sensing the weight of the chair 116 as well as when the chair moves laterally. The electronic controller 119 uses wireless signals indicating a sensed weight that the caster 118a is experiencing, for example when an individual sits in the chair 116. This may be accomplished in one way by implementing the pressure sensor as a pressure sensitive switch that detects when a minimum weight (e.g., 20-40 lbs) is being supported by the caster 118a. If the accelerometer 120 is incorporated, the electronic controller 119 may also receive signals indicating a sensed motion, such as when the chair moves. Other information, such as GPS sensed location, temperature and humidity could also be sensed by suitable components and/or sensors used by the system 10. The wireless signals may be sent via a proximity located Internet application gateway 126 and/or gateway 128 to a cloud based management server 130. The wireless signals may be interpreted by a suitable algorithm running on the cloud-based management server 130 to determine when the chair 116 is occupied by a user and when the user is standing while working at his/her computing device 110 and/or using his/her smartphone 112. To this end it will be understood that the smartphone 112 also preferably includes its own short range wireless transceiver (e.g., BLUETOOTH® wireless communications protocol transceiver) that enables the system 100 to detect that the smartphone is present at the desk system 102. This feature may be used to verify the user that is working at the desk system 102. The cloud-based management server 130 may monitor and log times that it detects that the user is working at the desk system 102 while standing.

The chair 116 may also optionally include a pressure sensitive seat pad 132 as well as at least one optical sensor 134. Each of the seat pad 132 and optical sensor 134 may include a short range communications transceiver (e.g., BLUETOOTH® wireless communications protocol transceiver) for communicating information to one or more of the Internet gateways 126 and/or 128. The seat pad 132 may also include any suitable internal mechanism for generating vibration in response to an electrical signal.

To further aid in detecting or confirming when the user is standing and when he/she is seated in front of the desk system 102, an optional pad 136 may be used on which the chair 116 is able to roll around. The pad 136 may incorporate a grid-like pressure sensor network 138 comprised of an X-Y grid of independent pressure sensors that are each able to sense a weight present thereon. The weight sensing ability of each of the sensors of the pressure sensor network 138, together with a suitable controller and one or more algorithms running on the controller, may be able to generate information that not only informs when the user has seated himself/herself at the chair, but also when the user is standing, and when the user is moving his/her feet positions on the pad 132. This information may be transmitted to the cloud-based management server 130 via a short range wireless transceiver (e.g., BLUETOOTH® protocol transceiver) in real time. Thus, by determining the pressure at specific sensors, and exactly where such pressure is being sensed on the X-Y grid of sensors of the pressure sensor network 138, it can be reliably determined whether the user is seated in the chair 116 or is standing on the pad 136. This information may be used to further increase the accuracy of detection as to when the user is standing or seated in front of the desk system 102, as well as how long the user is present in either orientation (i.e., either standing or seated). Such as sensor network as the network 138 may also provide sufficient intelligence to be able to discern when a user has simply set a box, a backpack or some other relatively heavy item in the chair 116, in which case it would be important for the system 100 to know this condition.

The desk system 102 may also incorporate an infrared sensor 140 and/or a sonar sensor 142. Each of these sensors may also incorporate its own short range wireless communications transceiver (BLUETOOTH® wireless communications protocol) for transmitting signals to a nearby one of the Internet gateways 126 and/or 128, which may then be relayed to the cloud-based management server 130. The infrared sensor 140 and the sonar sensor 142 may likewise provide signals that one or more algorithms running on the cloud-based management server 130 interpret to determine and/or confirm that a user is seated or standing at the desk system 102.

The cloud-based management server 130 may communicate with one or more health/fitness applications 144 to report health related information pertaining to the user while the user is using the desk system 10. For example, the cloud-based management server 130 may report the time duration and/or estimated calories burned at the end of every time interval that the user has been standing while working at the desk system 102. The cloud-based management server 130 may also communicate with a health care provider 146 to report such information to the health care provider. The health care provider may use this information to provide premium discounts to the user. For example, the health care provider may provide a discount to the user if the user accumulates a predetermined minimum number of standing minutes at the desk system 102 over the course of an entire calendar year. If the employer is self-insured, then this information could be reported directly to the employer's human resources department via the corporate IT department.

The cloud-based management server 130 may also communicate via the Internet, or possibly through one of the Internet gateways 126 and/or 128, with the servers of a corporate IT department 148. The corporate IT department may have an email server 150 which handles the user's email account 152 as well as the user's calendar 154. An important feature of the system 100 is that a software plug-in 156 is used with the email server 150 which allows the cloud-based management server 130 to monitor the user's calendar, and to email the user with notifications regarding upcoming opportunities to perform a work task while standing rather than sitting, or alternatively to push notifications to the screen of the user's computing device 110 reminding the user of the opportunity to carry out the upcoming event while standing. For example, the cloud-based management server 130 may detect from the user's calendar that the user has a webinar coming up later in the day. Shortly before the webinar is scheduled to start, the cloud-based management server 130 may notify the user with a reminder to consider standing for the duration of the webinar. The reminder may take the form of an email to the user, a screen notification displayed on the screen of the user's computer 110, a text message to the user's smartphone 112, causing a vibration of the seat pad 132, illuminating some external light (e.g., LED), etc. If a screen notification is used, the cloud-based management server 130 may accomplish this by “pushing” the notification to the display of the user's computing device 110 notifying the user of the opportunity to stand for the duration of the webinar. Optionally, the cloud-based management server 130 may periodically notify the user when the user has reached a predetermined threshold for a given time period (e.g., 1000 minutes for the current month, 1000 calories burned threshold, etc.). Still further, the cloud-based management server 130 may be used to remind the user through emails or pushed notifications that the user is approaching a predetermined number of “standing minutes” which qualifies the user for a company sponsored prize. And as mentioned above, the user's number of accumulated standing minutes during a given time period (e.g., month), as well as the estimated number of additional number of calories burned by the user while standing, can also be logged into the one or more fitness programs 144 that the user has set up for his personal use.

Still another feature of the system 100 is the ability to integrate warnings or notifications from a building emergency monitoring/notification system 158. The cloud-based management server 130 may communicate with the emergency monitoring/notification system 158 and when a warning has been issued, for example a fire alarm, the user may push a notification on to the screen of the user's computing device 110. In this manner, even if the user is listening to a webinar via headphone, or otherwise listening to music while performing routine work tasks, and otherwise would not be able to hear a fire alarm warning, the user would still be notified immediately of the emergency condition. Alternatively, an electrical signal may be sent to the pressure sensitive seat pad/vibration mechanism 132 to cause vibration that the user will feel. This feature can also alert the user to an emergency situation in the event that the user is not viewing the display of the user's personal electronic device 110. The emergency situation may be a security situation that has developed in the building where the user is located or possibly even a weather related emergency condition that has developed.

As one example of how the system 100 may operate, the user may be seated as the chair 116 performing certain work before a scheduled webinar is about to attend. The cloud-based management server 130, through its continuous monitoring of the user's calendar 154, may determine that the webinar is about to start in 15 minutes. The cloud-based management server 130 may cause use the plug-in to generate an email notification to the user's email account 152 which shows up in the user's email In Box, which suggests to the user to stand during the upcoming webinar. Alternatively a notification may be pushed to the user's screen to remind the user of the opportunity to stand during the upcoming webinar. If an email reminder is sent, the user may be presented with an option to reply to the reminder email and to select a “YES” option or a “NO” option within the body of the reply. If the user selects “YES”, then the cloud-based management server 130 may transmit a command to the motor/control system 104 which automatically begins slowly raising the desk surface 106 shortly before the webinar is schedule to start (e.g., maybe 2-3 minutes prior to the webinar starting). This would eliminate the possibility of the user intending to stand during the webinar, but simply forgetting to raise the desk surface 106 when the webinar starts. Alternatively, the desk system 102 could be equipped with a switch 160 which is mounted at a convenient location, for example under the desk surface 106 but easily accessible by the user, which the user can actuate to command the motor/control system 104 to raise or lower the desk surface 106. Other controls could be incorporated into the motor/control system 104, and or into the switch 160, to enable the user to configure the desk system 102 so that the desk surface 106 is raised to a programmed height whenever the desk surface is to be used while the user is standing. Obviously, one or more additional sensors could be associated with the desk system 102 to interrupt a lowering motion of the desk surface 106 if it is detected that some object has been placed under the desk which would interfere with fully lowering the desk surface 106.

Still another option would be an automatic raising of the desk surface 106 by the cloud-based management server 130 just prior to a scheduled telecon or other event, with a notification to the user a few seconds before the raising action begins. The cloud-based management server 130 may provide the user with the opportunity to override the raising action and maintain the desk surface 106 in its lowered orientation, by selecting an option presented on the display of the user's personal electronic device 110. This may further encourage user's to stand and use the desk surface 106 in its elevated orientation.

Further to the above example, once the webinar has concluded, the system 100 could be programmed to leave the desk surface 106 in its raised orientation until the user specifically commands that the desk surface 106 be lowered. Such a command could be given by the user through actuation of the switch 160. Optionally, a command selection could be pushed onto the screen of the user's computing device 170 (e.g., “Lower or “Leave Raised”) so that the user can make the command selection by using his/her mouse and clicking on the appropriate command.

The system 100 could also be programmed with a number of “default” actions. For example, any time the cloud-based management server 130 detects certain upcoming events (e.g., telecon; webinar; video conference, etc.), the system 100 could be programmed so that the motor/control system 104 will automatically notify the user that the desk surface 106 will be raised in the next 2-3 minutes unless the user inputs a command to leave the desk surface 106 in its lowered condition. This would also encourage the user to at start the event (telecon, webinar, etc.) in the standing position. If at any time during the event the user feels he/she needs to perform the remainder of the event while seated, the user may simply actuate the switch 160 to lower the desk surface 106.

Referring further to the chair caster 118a shown in FIG. 2, it was noted that the caster may be a retrofittable part. By “retrofittable” it is meant that the caster may be made specifically to fit a certain make/model of chair. In this case one of the existing casters of the chair can be removed and the caster 118a simply inserted in its place. This makes it extremely easy and cost effective to integrate the functionality of the caster 118a into a wide range of chairs available from various office furniture manufacturers. It is also possible that the chair 116 may be constructed and sold with the caster 118a already installed. In either event, the functionality of the caster 118a can be added to the chair with only a limited amount of additional expense. It is also possible that the functionality of the caster 118a could be incorporated into a track-ball mouse like assembly which is affixed to one of the legs of the chair. The track-ball mouse like assembly may be clamped or otherwise fixedly or removably attached to the chair leg so that it is in contact with a floor surface (or pad or matt) on which the chair 116 is positioned. Movement and pressure acting on the ball of the track-ball mouse like assembly could be used to sense both acceleration and pressure that the chair 116 is experiencing and to provide signals indicating when the user is seated or standing.

It will be appreciated, then, that a principal advantage of the integrated work desk system 100 is its ability to not just monitor whether the user is seated or standing, but to integrate and leverage the use of other subsystems (email, calendar, user's smartphone, etc.) to make using the desk system 102 in its raised orientation as easy and convenient for the user as possible, as well as to proactively encourage the user to perform various activities in a standing, rather than seated, orientation. In various embodiments described herein the work desk surface 106 may be raised and lowered quickly and easily by a command from the user, or may be configured to automatically rise just prior to certain events (e.g., webinar, telecon, etc.) if the user does not command otherwise. Accumulated standing time can be logged by the system 100 and reported to various other entities or subsystems, as well as to the user's employer.

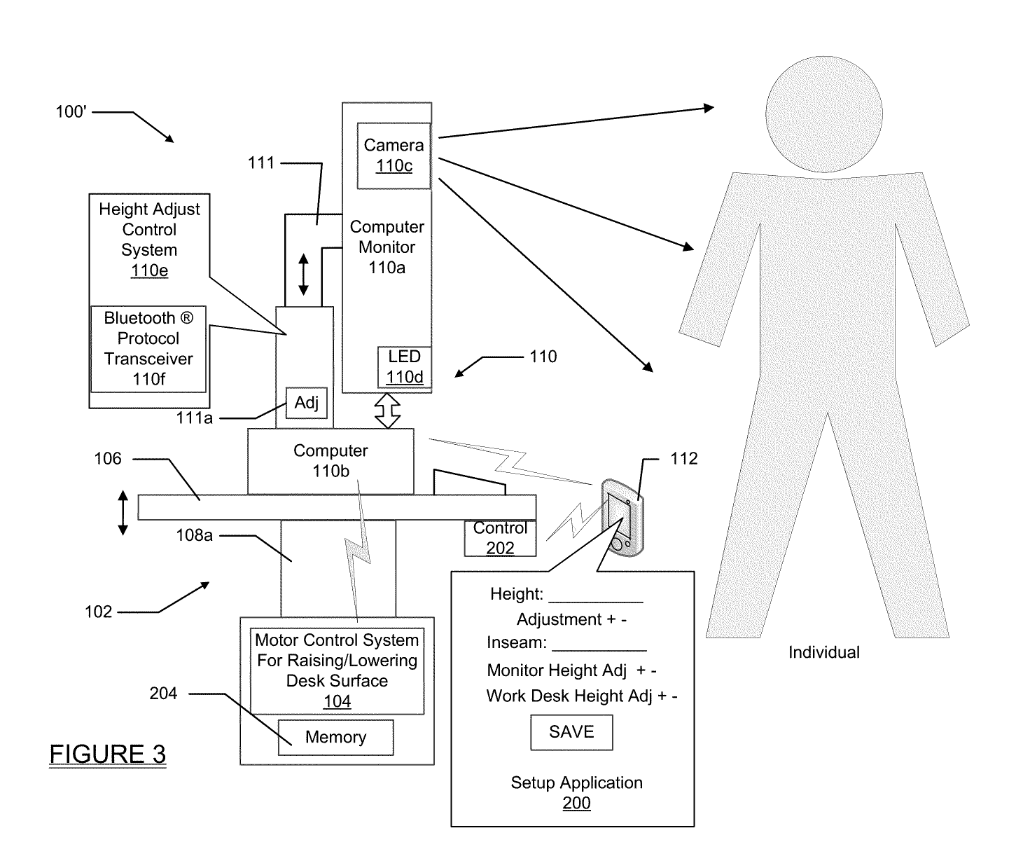

Referring to FIG. 3, there is shown a high level diagram explaining a system 100′ which is able to automatically raise and/or lower the desk surface 106 to an optimal height for a given user. The user's personal electronic device 110 in this example is shown as a desktop computer having a monitor 110a and a computer system 110b. The monitor 110a is supported by a telescoping support arm 111 which enables the monitor 110a to be raised and lowered relative to, and independently of, the work desk surface 106.

The monitor 110a has a built in camera 110c which can be used to image the individual at select areas such as the eyes and elbows, and an LED 110d or other similar optical element which can either be built in to the monitor frame or otherwise attached to the front of the monitor 110a such as by adhesives. The telescoping support arm 111 has a separate height adjustment control system 110e built in that includes a short range wireless transceiver, for example a Bluetooth® protocol wireless transceiver 110f. The computer system 110b may also receive information input by the user on a setup application 200 which is loaded on the user's smartphone 112 (or alternatively on any other electronic device of the user such as a tablet). The setup application 200 may allow the user to input his/her height and possibly his/her inseam measurement as well. Based on these measurements, the setup application 200 may determine a suggested optimum height for the desk surface 106 as well as a suggested optimum height for the monitor 110a, and then position the desk surface 106 at the recommended optimum height using the motor control system 104 and the monitor height adjustment control system 110e. The setup application 200 may also allow the user to make fine adjustments to the height of the desk surface 106 and the height of the monitor 110a and then to save these settings to memory. Thereafter, whenever the user approaches the system 10 and the setup application 200 is running on the user's smartphone 112, a wireless Bluetooth® protocol communications link is established with the computer system 110b and/or the motor control system 104 and/or the height adjustment control system 110e, which enables the desk surface 106 height and the monitor 110a to be automatically adjusted to the user's stored settings without any action being required by the user. The presence of the user may optionally be detected by the camera 110c using any suitable optical recognition software running on the computer system 110b, and automatic implementation of the height adjustment settings for the desk surface 106 and the monitor height may be carried out once the specific user is identified using the camera 110c.

The camera 110c may also be used, with suitable software, to analyze key features of the user's anatomy such as the height at which the user's eyes are at when the user is seated at the system 10 and facing the monitor 110a, as well as the location of the user's elbows. Based on the detected positions of the user's eyes and elbows, the system 10 may control the motor control system 104 and the height adjustment control system 110e to adjust the height of the desk surface 106 and the height of the monitor 110a to optimum heights. It is also contemplated that a third party software system may be used to obtain measurements using the camera 110c, and to make recommendations on the setting of the desk surface 106 height and/or the monitor 110a height.

Still further, the LED 110d could be used in a slightly less sophisticated implementation to provide a signal to the user that the desk surface 106 is at a previously set height for the user. For example, the user may “save” a specific work desk height either by using a suitable software application program running on the computer system 110b or through a “SAVE” command available on the setup application 200. When the user sits down in the chair 116 in front of the monitor 110a, the user may use a control 202 that is coupled to the motor control system 104 to adjust the height of the desk surface 106 either up or down. When the desk surface 106 reaches the user set height as it is being raised or lowered, the LED 110d may be caused to blink to indicate to the user that the work desk is at the preset height for the user. The blinking of the LED 110d may be controlled by the setup application 200 running on the user's smartphone, or by a signal from the motor control system 104 that is applied to the LED 110d. In this latter implementation, the motor control system 104 uses a connection (i.e., cable) coupled to the LED 110d to provide power to the LED 110d to cause the LED 110d to flash when the user set height is reached. In this regard the motor control system 104 may also include non-volatile memory 204, for example non-volatile RAM, which stores a preset height for the user therein. A separate manually accessible “fine” adjust control 111a may be associated with the monitor height adjustment control system 110e enable the user to make a fine adjustment to the height of the monitor 110a.

Instead of just one LED 110d, it is contemplated that a multicolor LED or a plurality of LEDs 110d may be used. For example, red, yellow and green LEDs may be used with the red LED being illuminated at the desk surface 106 is being raised, and with the yellow LED being turned on (and the red LED off) when the desk surface 106 is within a small range (e.g., 50 mm below or above an optimum determined height), and a green LED illuminated (and the yellow LED turned off) when the desk surface 106 is at the optimum determined height (or a previously saved height).

An important advantage of the system 10 is that actual objective measurements are taken for the height of the desk surface 106 using the sonar sensor 142 and/or the infrared system 140. As such, highly accurate height measurements are used to accurately set the height of the desk surface 106. The system 10 does not rely on estimating where the desk surface 106 is at relative to the floor.

The memory 204 may have sufficient capacity to store preset heights for a plurality of different users. For example, three different users may be required to share use of the desk system 102. Each of the users may perform the setup procedure described above using the setup application 200 running on his/smartphone 112. Afterwards, whenever any of the users sits down at the chair in front of the system 100, a wireless Bluetooth® protocol communications link will be established between the user's smartphone 112 and the motor control system 104 and/or the transceiver 110f of the height adjustment control system 110e, and/or the monitor height adjustment control system 110e. The wireless communications link may be used to send a command to the motor control system 104 and/or the monitor height adjustment control system 110e, or may identify the user to the motor control system 104 and/or the system 110e. In either event, the height adjustment of the desk surface 106 and/or the height adjustment of the monitor 110a may be made automatically using the systems 104 and 110e without any further input or action by the user. This feature enables highly convenient use of the system 100 by a number of individuals in a given work environment.

The systems 10, 100 and 100′ thus both help to promote the user's health and well-being and to encourage additional cardiovascular activity by either walking or standing during those periods of the day where the user would otherwise be carrying out a task seated in a chair, but where the task could just as easily be carried out while walking at a comfortable/leisurely pace on a treadmill, or simply by standing.

A wide variety of tasks such as webinars, employee training, answering voicemail messages, responding to emails and other activities can easily be carried out while standing or while walking at a comfortable pace, and without causing such exertion that the individual would begin to perspire. The systems 10 and 100 provide the valuable advantage that the individual may obtain additional cardiovascular benefits to such an extent that the individual may be able to dramatically reduce the time that he/she spends after work exercising at a gym or health club. This means that more time outside of an individual's working hours would be free for family or other activities. But most importantly, the overall health and well being of employees of the enterprise may be improved, thus helping to reduce health related costs for the enterprise.

While various embodiments have been described, those skilled in the art will recognize modifications or variations which might be made without departing from the present disclosure. The examples illustrate the various embodiments and are not intended to limit the present disclosure. Therefore, the description and any claims should be interpreted liberally with only such limitation as is necessary in view of the pertinent prior art.

1. A system operable to monitor use of a furniture component by a user, comprising:
an electronic caster system coupled to the furniture component for helping to provide rolling movement of the furniture component along a floor surface, and for sensing when an individual is present on the furniture component, and communicating information relating to the presence of the individual on the furniture component; and
a remotely located management system configured to wirelessly communicate with the electronic caster, to receive information relating to when the user is present on the furniture component.

2. The system of claim 1, wherein the furniture component comprises a chair.

3. The system of claim 2, wherein the system further comprises a work desk able to be positioned at first and second elevations, the first elevation being suitable for performing work on a desk surface of the work desk while seated in front of the work desk, and the second elevation being suitable for performing work on the desk surface while said standing in front of the work desk.

4. The system of claim 3, wherein the electronic caster system includes a short range wireless transceiver for assisting in communicating wirelessly with the remotely located management system.

5. The system of claim 1, wherein the electronic caster system includes an electronic controller.

6. The system of claim 2, wherein the electronic caster system includes an accelerometer for detecting when the chair is moving on the floor surface.

7. The system of claim 2, wherein the electronic caster system includes a pressure sensor for sensing when an individual is seated in the chair.

8. The system of claim 1, wherein the electronic caster system includes a battery for powering electronic components located in the electronic caster system.

9. The system of claim 1, further comprising an Internet gateway subsystem for facilitating wirelessly communications between the electronic caster system and the remotely located management system.

10. The system of claim 3, wherein the work desk has a wireless communications system for assisting in communicating with the remotely located management system.

11. The system of claim 3, wherein the work desk has at least one of:
an infrared sensor for detecting a presence of an individual in a vicinity of the work desk; or
a sonar system for detecting a height that the desk surface of the work desk is at.

12. The system of claim 1, wherein the remotely located management system is configured to communicate with a corporate information technology (IT) department and a personal computing device (PED) that an individual is using at the work desk to at least one of:
compile usage information on the time that the individual is standing while working at the work desk and report the usage information to at least one of the individual or the IT department;
to monitor the user's calendar and to send a notification to the user's PED reminding the user of an upcoming event on the user's calendar during which the individual could participate while standing at the work desk; and
to provide emergency notifications to the user's PED.

13. The system of claim 10, wherein the work desk includes a motor control system having a wireless transceiver for communicating wirelessly with the remotely located management system and for receiving commands from the remotely located management system to enable at least one of raising or lowering of the desk surface of the work desk in response to a command received from the remotely located management system.

14. The system of claim 1, further comprising a pressure sensitive floor mat upon which the furniture component is placed, the pressure sensitive mat configured to detect whether an individual is standing at the furniture component and to generate a signal indicative.

15. A method for monitoring use of a furniture component by a user, comprising:
using an electronic caster system coupled to the furniture component to help provide rolling movement of the furniture component along a floor surface;
using the electronic caster system to sense when an individual is present on the furniture component;
using a wireless communications system associated with the electronic caster system to relate a presence of the individual on the furniture component; and
using a remotely located management system configured to wirelessly communicate with the electronic caster, to receive information relating to when the user is present on the furniture component.

16. The method of claim 15, wherein the operation of using an electronic caster system coupled to a furniture component comprises using an electronic caster system coupled to a chair for sensing when an individual is seated in the chair.

17. The method of claim 16, further comprising using a work desk having a desk surface movable between at least two different elevational positions.

18. The method of claim 16, further comprising using a sensor to sense lateral movement of the chair.

19. The method of claim 15, further comprising using the remotely located management system to provide information concerning usage of the chair to a remote information technology (IT) department.

20. A system for controlling a height position of a monitor positioned adjacent a desk surface of a work desk, the system comprising:
a height adjustment control system including a support member for supporting the monitor and positioning the monitor at a selected elevation;
a motor control system for adjusting a height of the desk surface of the work desk; and
wherein the height adjustment system and the motor control system operate to adjust at least one of an elevational position of the support member or the desk surface height to place the monitor at a comfortable viewing elevation for the user.
